(19) United States
(12) Patent Application Publication
(10) Pub. No.: US 2026/0338545 A1
(43) Pub. Date: Oct. 29, 2026

(54) METHOD AND APPARATUS FOR MEASURING A WORKPIECE USING A DISTANCE SENSOR MOVED ALONG A TRAJECTORY

(71) Applicant: JENOPTIK Optical Systems GmbH, Jena (DE)

(72) Inventors: Lutz JACOB, Jena (DE); Michael SCHUBERT, Jena (DE); Jakob HENKEL, Jena (DE)

(73) Assignee: JENOPTIK Optical Systems GmbH, Jena (DE)

(21) Appl. No.: 19/659,528

(22) Filed: Apr. 27, 2026

(30) Foreign Application Priority Data
Apr. 29, 2025 (DE) 10 2025 001 493.7

(51) Int. Cl. G01B 11/24; G01B 11/00; G06T 7/62; G06T 7/70

(52) U.S. Cl. CPC G01B 11/24; G01B 11/005; G06T 7/62; G06T 7/70; G06T 2207/20221; G06T 2207/30164

(57) ABSTRACT

A method and apparatus for measuring at least one feature of the shape, position or dimension of a rotatably clamped workpiece. Multiple configurations of a displaceable and/or rotatable distance sensor are calculated, each of the configurations comprises a respective sensor position and a respective sensor angle of the distance sensor. Measured values are recorded for generating a first data set. The displaceable and/or rotatable distance sensor are controlled to adopt a sequence of the configurations using a control unit. A respective distance between the distance sensor and a respective surface position on the surface of the workpiece in the respective configuration of the distance sensor are measured. The configurations are calculated in such a way that the respective distance is measured in a predefined angular range and in a predefined distance range with respect to the surface of the workpiece at the respective surface position.

This nonprovisional application claims priority under 35 U.S.C. § 119(a) to German Patent Application No. 10 2025 001 493.7, which was filed in Germany on Apr. 29, 2025, and which is herein incorporated by reference.

### BACKGROUND OF THE INVENTION

### Field of the Invention

The invention relates to a method for measuring a shape, position or dimension features of a workpiece, in particular of rotatable machine elements, for example motor and transmission shafts, thrust rods, valves, pistons, screws, turbine parts, etc.

### Description of the Background Art

For an accurate measurement of workpieces, in particular of wave-like workpieces, tactile measurement methods have become established in which surfaces can be probed with mechanical probing elements and measured very accurately. Contactless measurement methods are likewise used for distance measurement, for example optical distance sensors.

Optical measurement methods which produce a shadow image of the workpiece, on which the outer contour can be measured, are suitable for supplementation. Due to the contactless measurement, the workpiece can be detected quickly and measured with high accuracy. It is possible to easily and quickly switch between different measurement tasks. A disadvantage of the shadow image is that, for example, concave partial surfaces and undercuts which are not visible in the shadow image cannot be measured.

It is therefore appropriate to combine the measurement method with distance measurement by means of a distance sensor and the measurement method with a shadow image. By rotating the wave-like workpiece about its longitudinal axis and repeatedly measuring the distance and recording shadow images, its shape and dimensions can be completely captured.

DE 10 2012 104 008 B3, which corresponds to US 2013/0300861, which is incorporated herein by reference, discloses an apparatus for measuring the shape and dimensions of a rotatable wave-like workpiece, in which the measurement method with a shadow image and the measurement method with distance measurement by means of a distance sensor can be carried out in combination. The apparatus contains a machine bed with a linear guide arranged along the machine bed and a linear guide system arranged parallel thereto, a workpiece holder for rotatably receiving the workpiece and an optical measuring unit with an illumination module and a camera module for recording shadow images of the workpiece. In addition, the apparatus contains an additional mechanical measuring unit with a tactile distance sensor, wherein the mechanical measuring unit is fixed to the optical measuring unit and has a pivoting device for pivoting the tactile distance sensor in a plane orthogonal to the axis of rotation of the workpiece.

WO 2022/053929, which corresponds to US 2023/0324169, discloses an apparatus for measuring the shape and dimensions of a rotatable wave-like workpiece, in which the measurement method with a shadow image and the measurement method with distance measurement by means of a distance sensor can be carried out in combination. The distance sensor is in this case in the form of an optical distance sensor. The distance sensor is mounted displaceably and rotatably on a holder. Thus, the distance sensor can be aligned in a suitable angular range with respect to the surface of a region of the workpiece to be measured, for example aligned with the flanks of a tooth of a gear wheel.

The reliability of the distance measurement with the distance sensor depends on the alignment and distance of the distance sensor with respect to/from the surface of a region of the workpiece to be measured. The methods known from the prior art for measuring the shape and dimensions of a rotatable workpiece do not disclose any method steps in respect of how to control the distance sensor in order to obtain an optimum alignment and an optimum distance and thus a high degree of reliability for the distance measurement. Thus, the measured data relating to the shape and dimensions of the workpiece are not reliable.

### SUMMARY OF THE INVENTION

It is therefore an object of the invention to provide a method for measuring at least one feature of the shape, position or dimension of a workpiece in which the alignment of the distance sensor is controlled in such a way that a reliable data set relating to the shape, position or dimension of the workpiece is produced.

The method according to an example of the invention for measuring at least one feature of a shape, position or dimension of a rotatably clamped workpiece can comprise: calculating multiple configurations of a displaceable and/or rotatable distance sensor, wherein each of the configurations comprises a respective sensor position and a respective sensor angle of the distance sensor; recording measured values for generating a first data set, comprising: controlling the displaceable and/or rotatable distance sensor to adopt a sequence of the configurations using a control unit; measuring a respective distance between the distance sensor and a respective surface position on the surface of the workpiece in the respective configuration of the distance sensor; calculating a respective coordinate set relating to the respective surface position from the respective sensor position and the respective sensor angle of the respective configuration and the respective distance; and generating the first data set from the coordinate sets, wherein the first data set describes the at least one feature of the shape, position or dimension of the workpiece. Whereby the configurations can be calculated in such a way that the respective distance is measured in a predefined angular range and in a predefined distance range with respect to the surface of the workpiece at the respective surface position.

The method may additionally comprise: illuminating the workpiece using an illumination unit; recording a shadow image of the workpiece, which is generated by the illumination unit, at least a single time using a sensor unit; generating a second data set from the at least single recording of the shadow image; and combining the first data set and the second data set to form a third data set, wherein the third data set describes the at least one feature of the shape, position or dimension of the workpiece.

The at least one feature of the shape, position or dimension of the workpiece can be, in particular, a quantitative feature. The at least one feature can be, for example, a diameter of the workpiece or a coordinate of the surface position. The surface position can be, for example, a tooth of a gear wheel which is mounted on a shaft of the workpiece. The workpiece can be, in particular, a wave-like workpiece.

The distance sensor can be mounted on a carrier. The distance sensor can be a tactile distance sensor which measures the distance between the distance sensor and a surface position on the surface of the workpiece, for example by means of a test needle. The distance sensor can be an optical distance sensor that optically measures the distance between the distance sensor and a surface position on the surface of the workpiece. The optical distance sensor can be, for example, a distance sensor according to the CCS principle, i.e. a confocal chromatic distance sensor.

The optional illumination unit and the optional sensor unit can likewise be mounted on this carrier opposite one another. The carrier may be U-shaped and encompass the workpiece.

In the method according to the invention, the distance sensor can carry out a contactless measurement of the distance, in particular an optical measurement of the distance, or a tactile measurement of the distance. An optical measurement of the distance can be carried out according to the CCS principle, i.e. according to the principle of a confocal chromatic distance sensor. A confocal chromatic distance sensor according to the CCS principle is advantageous on account of the high accuracy, short measurement time and small size of the distance sensor. An optical measurement of the distance can be carried out by way of a time-of-flight measurement of the light. An optical measurement can also be carried out with a laser range finder. In this case, the distance can be determined from a shift of the phase angle of amplitude modulation of the laser radiation between the emitted and received laser beam, in order to achieve better resolution. A contactless measurement of the distance can also be performed by measuring the propagation time of a sound signal or by means of a compressed air pulse. In the latter case, a measured dynamic pressure can be converted into a distance.

The predefined angular range with respect to the surface of the workpiece at the respective surface position may be an angular range close to the normal of the surface, advantageously an angular range from -30° to +30° with respect to the normal of the surface, particularly advantageously an angular range from -5° to +5° with respect to the normal of the surface. The predefined angular range may be the angular range of the distance sensor in which the distance sensor achieves its best accuracy when measuring the distance. The predefined distance range may comprise the operating distance of the distance sensor. The predefined angular range and the predefined distance range of the distance sensor thus depend on the type and the measurement principle of the distance sensor.

The distance sensor can be displaceable in at least one direction into a distance sensor position and/or is rotatable about at least one axis into a distance sensor angle.

The distance sensor may be configured in various configurations. One configuration may include, for example, a distance sensor position and a distance sensor angle. The distance sensor angle may comprise one or more angle coordinates, for example a horizontal distance sensor angle coordinate and a vertical distance sensor angle coordinate. It may be advantageous to provide only one angle coordinate, for example a horizontal one, because then only one distance sensor axis of rotation is required. The horizontal distance sensor angle coordinate can be an angle coordinate with respect to a distance sensor axis of rotation parallel to the axis of rotation of the workpiece.

Each of the configurations of the displaceable and/or rotatable distance sensor may comprise a distance sensor position and a distance sensor angle. The respective distance sensor position can be represented in coordinates using the components x, y and z. The respective distance sensor angle can be represented as an azimuth angle and a height angle.

The method according to the invention may involve the configurations being calculated taking into account target data relating to the workpiece, in particular taking into account design data relating to the workpiece. The target data relating to the workpiece, for example in the form of CAD data, can be used to calculate information about the target alignment of the surface at the respective surface position. It can be assumed that the actual alignment of the surface deviates only slightly from the target alignment. Therefore, the target data of the workpiece can be used to calculate a distance sensor position and a distance sensor angle of the distance sensor in such a way that the distance is measured in a predefined angular range and in a predefined distance range with respect to the surface of the workpiece at the respective surface position.

The configurations can be calculated in such a way that the displaceable and/or rotatable distance sensor is synchronously displaced and/or rotated in a trajectory, wherein the trajectory comprises the distance sensor positions and the distance sensor angles of the configurations.

To calculate the trajectory, the target data relating to the workpiece for the respective surface position can be used to calculate the direction of the normal to the surface. The direction of the normal can be used to calculate the distance sensor angle in such a way that the distance sensor detects the respective surface position in the predefined angular range with respect to the surface of the workpiece. The predefined angular range may advantageously include the angle for which the distance sensor functions reliably. The distance sensor position can be calculated from the surface position, the distance sensor angle and an operating distance between the surface position and the distance sensor. The operating distance is the distance between the surface position and the distance sensor for which the distance sensor functions reliably. Advantageously, the predefined distance range may include the operating distance. In the case of a tactile distance sensor, the operating distance is the length of the test needle. In the case of a contactless optical distance sensor, for example, the operating distance lies in a measurement range of the distance sensor. A configuration of the distance sensor comprises a respective distance sensor position and a respective distance sensor angle.

The calculation of the trajectory may comprise the steps of: selecting multiple surface positions for which a respective coordinate set is meant to be calculated;

for each surface position: calculating the direction of the surface normals of the respective surface positions, calculating the respective distance sensor angle within the predefined angular range with respect to the surface of the workpiece at the respective surface position, calculating the respective distance sensor position and calculating the respective configuration, wherein the respective configuration comprises the respective distance sensor angle and the respective distance sensor position; and determining a sequence of the configurations and arranging the configurations in a trajectory in such a way that the distance sensor is controlled to move the distance sensor along the trajectory with a minimum length of the trajectory or close to the minimum length of the trajectory.

The recording of measured values for generating a first data set may comprise: controlling the displaceable and/or rotatable distance sensor in the trajectory using a control unit; measuring a respective distance between the distance sensor and a respective surface position on the surface of the workpiece while the distance sensor is moving in the trajectory; calculating a respective coordinate set relating to the respective surface position from the respective distance sensor position and the respective distance sensor angle of the respective configuration and the respective distance; and generating a first data set, wherein the respective coordinate set relating to the surface positions that is determined by the distance sensor goes into the first data set.

The method according to the invention facilitates measurement of the respective distance between the distance sensor and multiple surface positions on the surface of the workpiece, wherein the distance sensor is guided along a trajectory in such a way that the distance is measured in a predefined angular range and in a predefined distance range with respect to the surface of the workpiece at the respective surface position. The predefined angular range and the predefined distance range are chosen in such a way that the distance sensor achieves its highest accuracy when measuring the distance. In addition, the displaceable and/or rotatable distance sensor is synchronously displaced and/or rotated in the trajectory, wherein the trajectory is optimizable for a minimum length. The method according to the invention therefore facilitates reliable and rapid measurement of the shape, position or dimension of a workpiece.

The method according to the invention can additionally comprise illuminating the workpiece using an illumination unit and recording a shadow image of the workpiece using a sensor unit. The sensor unit, for example a planar CCD camera or a line scan camera, is located on that side of the workpiece which lies opposite the illumination unit. Advantageously, the illumination can be effected with parallel light. A particularly accurate shadow image can then be recorded. Alternatively, the illumination can be effected with a point light source. Then, the shadow image can be dependent on the position of the illumination unit and the recording plane of the sensor unit.

During the illumination of the workpiece using the illumination unit, the generated shadow image of the workpiece can be recorded in a recording using the sensor unit. A second data set can be generated from this recording. The second data set can comprise at least one feature of the shape, position or dimension of the workpiece, for example a diameter of the workpiece. The first data set and the second data set can be combined to form a third data set, wherein the third data set describes the at least one feature of the shape, position or dimension of the workpiece.

In the method according to the invention, the first data set can contain, for example, at least one feature relating to the shape, position or dimension of the workpiece that is not contained in the second data set generated from the at least one shadow image. This can be a feature relating to the shape, position or dimension of concave partial surfaces and/or undercuts.

In the method according to the invention, the workpiece can be rotated about an axis of rotation. In the case of a wave-like workpiece, the axis of rotation is advantageously along the long direction of the wave-like workpiece. Likewise, the distance sensor can be displaced in a direction along the axis of rotation. Likewise, the illumination unit and/or the sensor unit can be displaced in a direction along the axis of rotation. As a result, further features of the shape, position or dimension of the workpiece can be measured.

In the method according to the invention, a first coordinate system of the displaceable and/or rotatable distance sensor and a second coordinate system of the sensor unit can be matched on the basis of a reference position. The reference position is a surface position on the surface of the workpiece, the coordinate set of which can be determined using both the distance sensor and the sensor unit. The reference position can be, for example, a tip attached to the workpiece or a surface position on a ring attached to the workpiece. The reference position can be selected as the surface position, and the reference position can be recorded as a shadow image by the sensor unit. The first data set can be generated using the distance sensor in the method according to the invention, wherein the first data set contains a coordinate set of the reference position in the first coordinate system. The second data set can be generated using the sensor unit in the method according to the invention, wherein the second data set contains a coordinate set of the reference position in the second coordinate system. A relationship between the distance sensor and the sensor unit can therefore be calculated from the combination of the first data set and the second data set in the third data set. This relationship can be, for example, an offset and/or a rotation between the first coordinate system and the second coordinate system.

The following can be carried out on a control unit, which can be, for example, a control and evaluation unit, and/or a computer: calculating the configurations of the distance sensor, recording and/or processing data relating to the measurement of the respective distance between the distance sensor and the respective surface position on the surface of the workpiece in the respective configuration of the distance sensor; calculating the respective coordinate set relating to the respective surface position from the respective sensor position and the respective sensor angle of the respective configuration and the respective distance; generating the first data set from the coordinate sets; and/or generating the second data set from the at least single recording of the shadow image; and/or combining the first data set and the second data set to form the third data set.

An apparatus according to the invention for measuring at least one feature of the shape, position or dimension of a rotatably clamped workpiece comprises a displaceable and/or rotatable distance sensor and a control unit, on which the method according to the invention can be carried out. The apparatus according to the invention can comprise an illumination unit and a sensor unit.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an apparatus for measuring the shape, position or dimension of the workpiece, on which the method according to the invention can be carried out;

FIG. 2 shows a view of the displacement and rotation unit and of the distance sensor;

FIGS. 3(a), 3(b), and 3(c) show different configurations of the displacement and rotation unit for measuring a distance using the distance sensor;

FIG. 4 shows a trajectory of the displacement and rotation unit for measuring a distance using the distance sensor;

FIG. 5 shows a flowchart of the method according to the invention;

FIG. 6 shows another flowchart of the method according to the invention; and

FIG. 7 shows the calculation of the distance sensor position and the distance sensor angle of the distance sensor.

### DETAILED DESCRIPTION

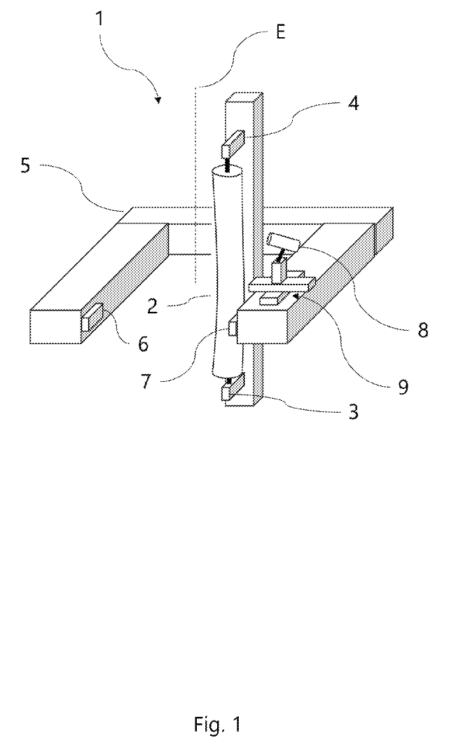

FIG. 1 shows an apparatus 1 for measuring the shape, position or dimension of a workpiece 2, on which the method according to the invention can be carried out. The workpiece 2 shown in FIG. 1 is a wave-like workpiece. The workpiece 2 is rotatably clamped between two holders 3, 4, wherein the rotation about an axis takes place parallel to a direction E. Alternatively, the workpiece 2 can also be rotatably clamped in only one holder. A U-shaped carrier 5 encompasses the workpiece 2. A sensor unit 6 and an illumination unit 7 are mounted on the carrier 5. The carrier 5 is displaceable along the direction E. The sensor unit 6, for example a planar CCD camera or a line scan camera, is located on that side of the workpiece 2 which lies opposite the illumination unit 7. A distance sensor 8 is mounted on a displacement and rotation unit 9.

The sensor unit 6 and the illumination unit 7 are not required for carrying out the method according to the invention as claimed in claim 1.

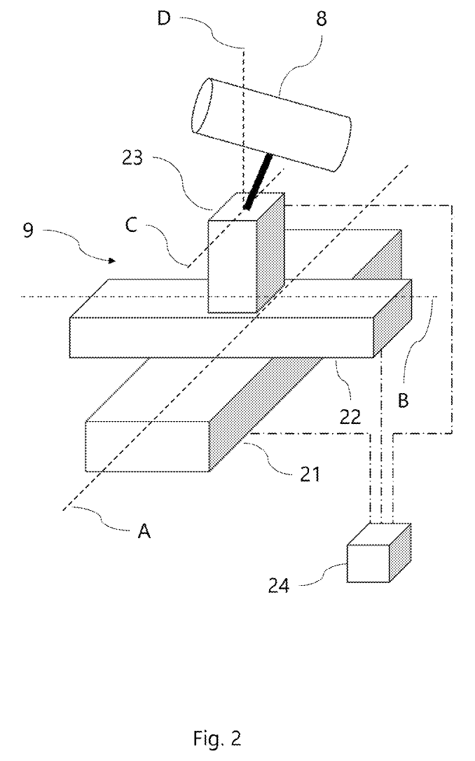

FIG. 2 shows the displacement and rotation unit 9 with the mounted distance sensor 8. The displacement and rotation unit 9 comprises a displacement element 21, a displacement element 22 and a rotation element 23. The displacement element 22 is mounted on the displacement element 21 and is displaceable along the direction A. The displacement element 22 is mounted substantially perpendicular to the direction A. The rotation element 23 is mounted on the displacement element 22 and is displaceable along the direction B. Direction A and direction B are substantially perpendicular to one another and also substantially perpendicular to the direction E. The distance sensor 8 is mounted on the rotation element 23 and is rotatable about the axis C and the axis D. The axis C is substantially parallel to the direction A. The axis D is substantially parallel to the direction E. Thus, the distance sensor 8 is displaceable along direction A and direction B and is rotatable about axis C and axis D. Displacement element 21, displacement element 22 and rotation element 23 are controlled by a control unit 24.

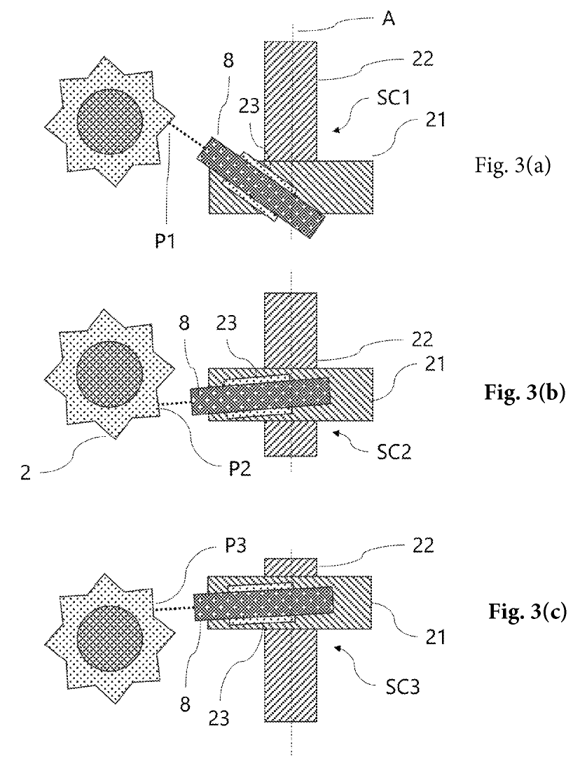

FIGS. 3(a), (b) and (c) show the distance sensor 8 in various configurations SC1, SC2 and SC3 during measurement of the distance between the distance sensor 8 and the surface positions P1, P2 and P3 on the surface of the workpiece 2. The view is of the workpiece 2 and the distance sensor 8 from above, i.e. the viewing direction is along the direction E. The dashed line between the distance sensor 8 and the workpiece 2 indicates the direction along which a distance between the distance sensor 8 and the workpiece 2 is measured. A measurement beam from an optical distance sensor or a measurement probe of a tactile distance sensor can be aligned along the dashed line.

FIG. 3(a): the control unit 24 controls the displacement element 21, the displacement element 22 and the rotation element 23 to adopt the distance sensor position and the distance sensor angle of the configuration SC1. The distance from the surface position P1 is measured by the distance sensor 8 at a small angle with respect to the normal of the surface at the surface position P1, the small angle being in a predefined angular range.

FIG. 3(b): the control unit 24 controls the displacement element 21, the displacement element 22 and the rotation element 23 to adopt the distance sensor position and the distance sensor angle of the configuration SC2. The distance from the surface position P2 is measured by the distance sensor 8 at a small angle with respect to the normal of the surface at the surface position P2, the small angle being in a predefined angular range.

FIG. 3(c): the control unit 24 controls the displacement element 21, the displacement element 22 and the rotation element 23 to adopt the distance sensor position and the distance sensor angle of the configuration SC3. The distance from the surface position P3 is measured by the distance sensor 8 at a small angle with respect to the normal of the surface at the surface position P3, the small angle being in a predefined angular range.

FIGS. 3(a), (b) and (c) shows the method according to the invention by way of example for three surface positions P1, P2, P3. The method according to the invention can be extended by further surface positions to the surface positions P1, P2, … PN.

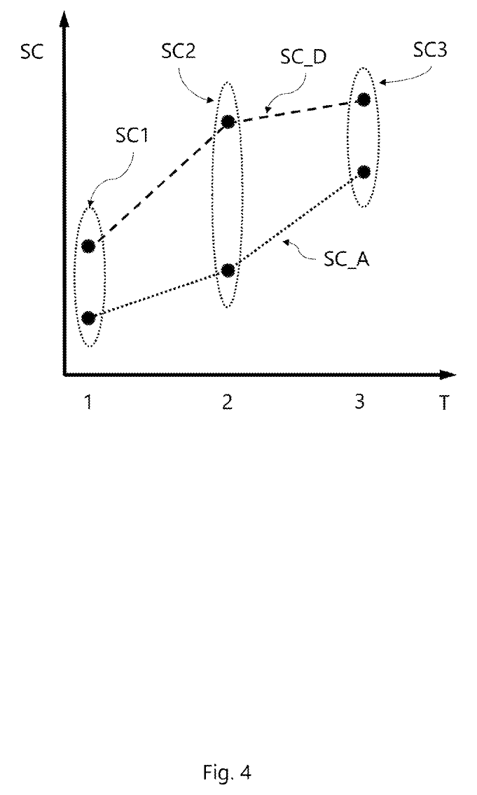

FIG. 4 shows an exemplary trajectory of the distance sensor position and the distance sensor angle of the distance sensor 8 with three positions on the trajectory. The respective distance sensor position and the respective distance sensor angle of the configurations are plotted over the positions on the trajectory T. The control unit 24 controls the distance sensor position SC_A along the axis A of the displacement element 22 and the distance sensor angle SC_D about the axis D of the rotation element 23 over the course of the trajectory.

Position 1 on the trajectory T: distance sensor position SC_A and distance sensor angle SC_D of the configuration SC1 are taken up.

Position 2 on the trajectory T: distance sensor position SC_A and distance sensor angle SC_D of the configuration SC2 are taken up.

Position 3 on the trajectory T: distance sensor position SC_A and distance sensor angle SC_D of the configuration SC3 are taken up.

The configurations SC1, SC2, and SC3 in FIG. 4 correspond, in qualitative terms, to the configurations SC1, SC2, and SC3 in FIG. 3.

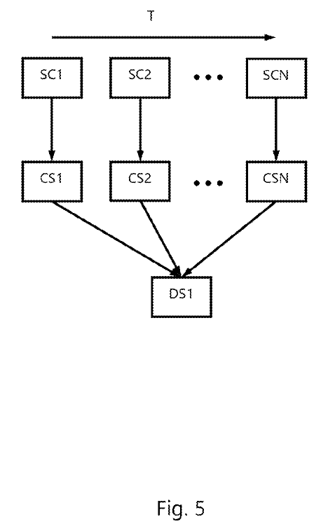

FIG. 5 shows the method according to the invention in a flowchart. The control unit controls the distance sensor on the trajectory T to adopt the configurations SC1, SC2 and possible further configurations up to a configuration SCN, wherein each of the configurations SC1, SC2, … SCN comprises a respective distance sensor position and a respective distance sensor angle. The following are carried out in each of the configurations SC1, SC2, … SCN: measuring a respective distance between the distance sensor and a respective surface position on the surface of the workpiece in the respective configuration of the distance sensor; and calculating a respective coordinate set relating to the respective surface position from the respective distance sensor position and the respective distance sensor angle of the respective configuration and the respective distance. The respective coordinate sets are referred to in FIG. 5 as CS1, CS2 and possible further coordinate sets up to CSN. A first data set DS1 is generated from the coordinate sets CS1, CS2, ... CSN.

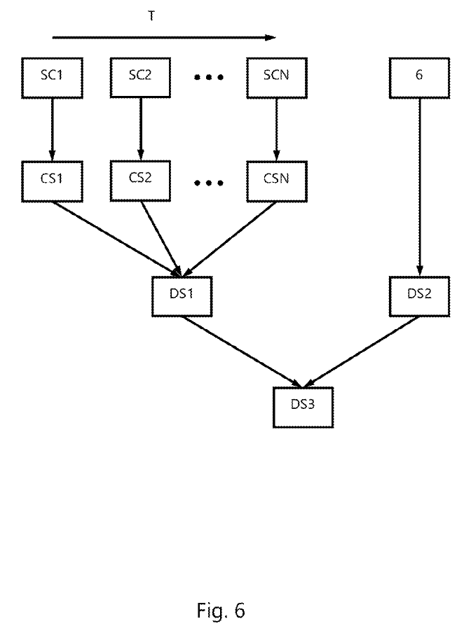

FIG. 6 shows the method according to the invention with additional recording of a shadow image using the sensor unit 6. The illumination unit 7 illuminates the workpiece 2, and the sensor unit 6 records a shadow image of the workpiece 2. A second data set DS2 is generated from the shadow image. The second data set DS2 contains information about the shape, position or dimension of the workpiece 2, which can be calculated from the shadow image, for example the diameter of the workpiece 2.

The data set DS1 is calculated in accordance with the description of FIG. 5.

The first data set DS1 and the second data set DS2 are combined to form a third data set DS3, wherein the third data set DS3 describes at least one feature of the shape, position or dimension of the workpiece 2.

In particular, the first data set DS1 can comprise information about at least one feature of the shape, position or dimension of the workpiece 2 that is not contained in the second data set DS2 generated from the at least one shadow image. In particular, the first data set DS1 can comprise information about a surface position in a concave or undercut region of the workpiece 2.

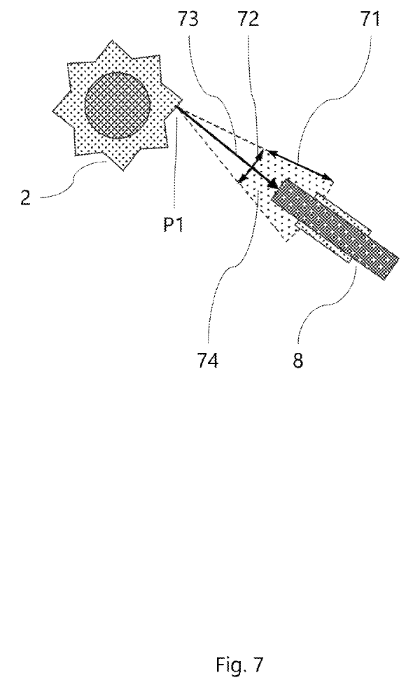

FIG. 7 shows how the distance sensor position and the distance sensor angle of the distance sensor 8 can be calculated for the surface position P1. A vector 73 is applied to the surface position P1. The length of the vector 73 is such that the vector 73 ends in the predefined distance range 71. The predefined distance range 71 comprises the operating distance of the distance sensor 8, the operating distance being the distance between the surface position P1 and the distance sensor 8 for which the distance sensor 8 functions reliably. The direction of the vector 73 is an angle in the predefined angular range 72 with respect to the surface of the workpiece 2 at the surface position P1. The distance sensor position is the end point of the vector 73. The end point of the vector 73 is located in the segment 74 identified by dotted lines. The distance sensor angle is the inverted direction of the vector 73. The distance sensor 8 thus measures the distance from the surface position P1 in the predefined distance range 71 and in the predefined angular range 72.

The method according to the invention is not restricted to the exemplary embodiments shown.

The invention being thus described, it will be obvious that the same may be varied in many ways. Such variations are not to be regarded as a departure from the spirit

and scope of the invention, and all such modifications as would be obvious to one skilled in the art are to be included within the scope of the following claims.

What is claimed is:

1. A method for measuring at least one feature of a shape, position or dimension of a rotatably clamped workpiece, the method comprising:
calculating at least two configurations of a displaceable and/or rotatable distance sensor, wherein each of the at least two configurations comprises a respective sensor position and a respective sensor angle of the distance sensor;
recording measured values for generating a first data set;
controlling the displaceable and/or rotatable distance sensor to adopt a sequence of the configurations using a control unit;
measuring a respective distance between the distance sensor and a respective surface position on a surface of the workpiece in the respective configuration of the distance sensor;
calculating a respective coordinate set relating to the respective surface position from the respective sensor position and the respective sensor angle of the respective configuration and the respective distance; and
generating the first data set from the coordinate sets, the first data set describing the at least one feature of the shape, position or dimension of the workpiece,
wherein the configurations are calculated such that the respective distance is measured in a predefined angular range and in a predefined distance range with respect to the surface of the workpiece at the respective surface position.

2. The method as claimed in claim 1, wherein the configurations are calculated taking into account target data relating to the workpiece or taking into account design data relating to the workpiece.

3. The method as claimed in claim 1, wherein the configurations are calculated such that the displaceable and/or rotatable distance sensor is synchronously displaced and/or rotated in a trajectory, and wherein the trajectory comprises the sensor positions and the sensor angles of the configurations.

4. The method as claimed in claim 1, wherein the predefined angular range is an angular range from -30° to +30° with respect to a normal of the surface, or an angular range from -5° to +5° with respect to the normal of the surface.

5. The method as claimed in claim 1, furthermore comprising rotating the workpiece about an axis of rotation of the rotatably clamped workpiece and/or displacing the distance sensor in a direction along the axis of rotation.

6. The method as claimed in claim 1, wherein the distance sensor carries out a contactless measurement of the distance, or an optical, acoustic or pneumatic measurement of the distance, or a tactile measurement of the distance.

7. The method as claimed in claim 1, wherein the first data set comprises information about a surface position in a concave or undercut region of the workpiece.

8. The method as claimed in claim 1, further comprising:
illuminating the workpiece using an illumination unit;
recording a shadow image of the workpiece, which is generated by the illumination unit, at least a single time using a sensor unit;
generating a second data set from the at least single recording of the shadow image; and
combining the first data set and the second data set to form a third data set, the third data set describing the at least one feature of the shape, position or dimension of the workpiece.

9. The method as claimed in claim 8, wherein the workpiece comprises a reference position, wherein the reference position is recorded as a shadow image by the sensor unit and the reference position is selected as the surface position, and wherein the method further comprises:
calculating a relationship between the distance sensor and the sensor unit from the at least one feature of the shape, position or dimension of the workpiece that is described in the third data set.

10. An apparatus for measuring at least one feature of the shape, position or dimension of a rotatably clamped workpiece, the apparatus comprising:
a displaceable and/or rotatable distance sensor; and
a control unit, wherein the method as claimed in claim 1 is performed.

11. The apparatus as claimed in claim 10, further comprising an illumination unit and a sensor unit.
